(19) United States
(12) Patent Application Publication
(10) Pub. No.: US 2024/0159102 A1
(43) Pub. Date: May 16, 2024

(54) WINDOW COVERINGS

(71) Applicant: Renee Holland, Kensington, GA (US)

(72) Inventor: Renee Holland, Kensington, GA (US)

(21) Appl. No.: 18/055,537

(22) Filed: Nov. 15, 2022

(51) Int. Cl. E06B 9/386; B32B 15/08; B32B 15/14; B32B 15/20

(52) U.S. Cl. CPC E06B 9/386; B32B 15/08; B32B 15/14; B32B 15/20; E06B 2009/2417

(57) ABSTRACT

Disclosure herein are window covering systems and methods of use thereof. The window covering systems may include a base material and a reflective material. The base material may be flexible and at least semitransparent to light within a visible spectrum. The base material may include a first side that faces a light source when in a first state, and a second side opposite the first side and that faces away front the light source when in the first state. The reflective material may be flexible, and opaque to light in at least one of an ultraviolent spectrum and an infrared spectrum.

### FIELD OF THE DISCLOSURE

The present subject matter relates to window coverings. More specifically, the present disclosure relates to window coverings having a reflective layer.

### BACKGROUND

Window coverings are used to cover windows so that people outside cannot see inside through the window and vice versa. The window coverings may allow light to enter to provide illumination. For example, window blinds may allow light to enter a room, but prevent people outside from seeing in.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A and 1B show a window covering system in first and second states, respectively, in accordance with at least one example of this disclosure.

FIGS. 2A and 2B show a window covering system in first and second states, respectively, in accordance with at least one example of this disclosure,

FIG. 3 shows a schematic of a window covering system in accordance with at least one example of this disclosure.

### DETAILED DESCRIPTION

Window covering systems covering windows and are used to prevent people outside from seeing inside. These systems have a problem in that they do allow the sun to heat a space. For example, during summer months, window covering systems are used to block out sunlight, but a room is still heated by the sun since the window covering system itself may be heated by the sun. In addition, ultraviolet light (UV) and infrared (IR) light may pass through the window covering systems and heat the room.

As disclosed herein, window covering systems may include one or more films applied to surfaces of a base material. The films may reflect light in the UV, IR, and/or visible spectrums. By reflecting light, the window systems may hinder radiation heat transfer. The hinderance of radiation heat transfer may allow the interior space to remain cool.

As disclosed herein, the films may be transparent, semitransparent, and/or opaque to visible light. The films may be transparent, semitransparent, and/or opaque to UV light. The films may be transparent, semitransparent, and/or opaque to IR light.

The above discussion is intended to provide an overview of subject matter of the present patent application. It is not intended to provide an exclusive or exhaustive explanation of the invention. The description below is included to provide further information about the present patent application.

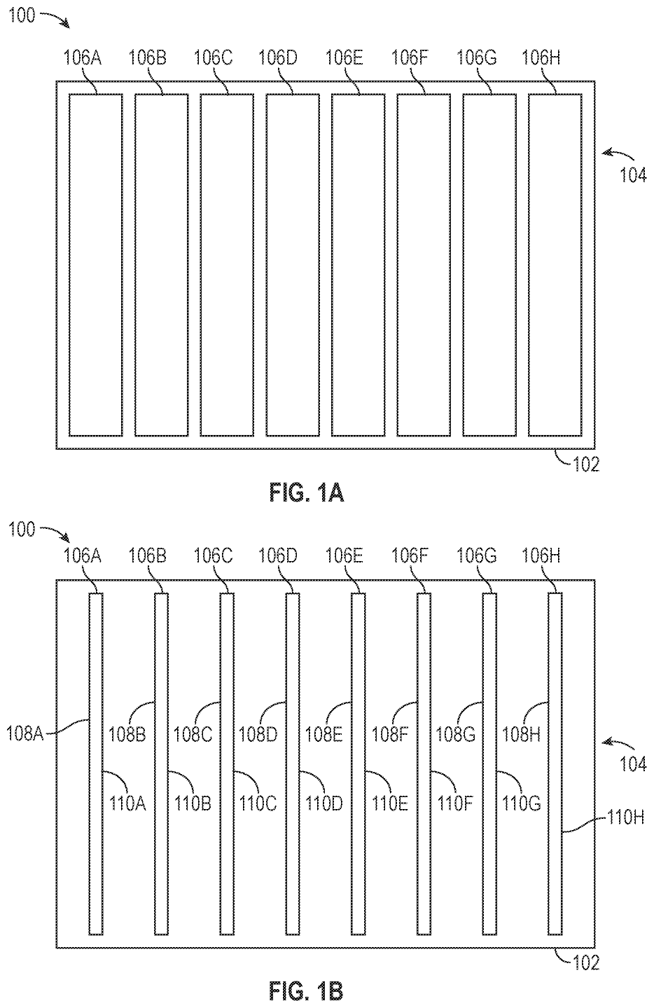

FIGS. 1A and 1B show a window covering system 100 in first and second states, respectively, in accordance with at least one example of this disclosure. Window covering system 100 may be suspended proximate a window 102. Window covering system 100 may include a base material 104 that is divided into strips 106 (labeled individually as strips 1061, 1068, 106C, 106D, 106E, 106F, 106G, and 106H). An example of base material divided into strips would be a louvered window blind. The strips, or louvers, may be suspended in a vertical or a horizontal position.

As shown in FIG. 1A, base material 104 may be in a first state or position. When a user wishes to allow light into a room or look outside, the user may rotate strips 106 to a second state or position as shown in FIG. 1B. When in the first state, first surfaces 108 (labeled individually as first surfaces 108A, 108B, 108C, 108D, 108E, 108F, 108G, and 108H) may face a light source, such as the sun. When in the first state, second surfaces 110 (labeled individually as second surfaces 110A, 1108, 1100, 110D, 110E, 110F, 110G, and 110H), which are opposite first surfaces 108, may face away from the light source. To rotate strips 106 from the first state to the second state, the second state to the first state, or any position in between the first and second states, a rod may be rotated as is known in the art for window blind systems.

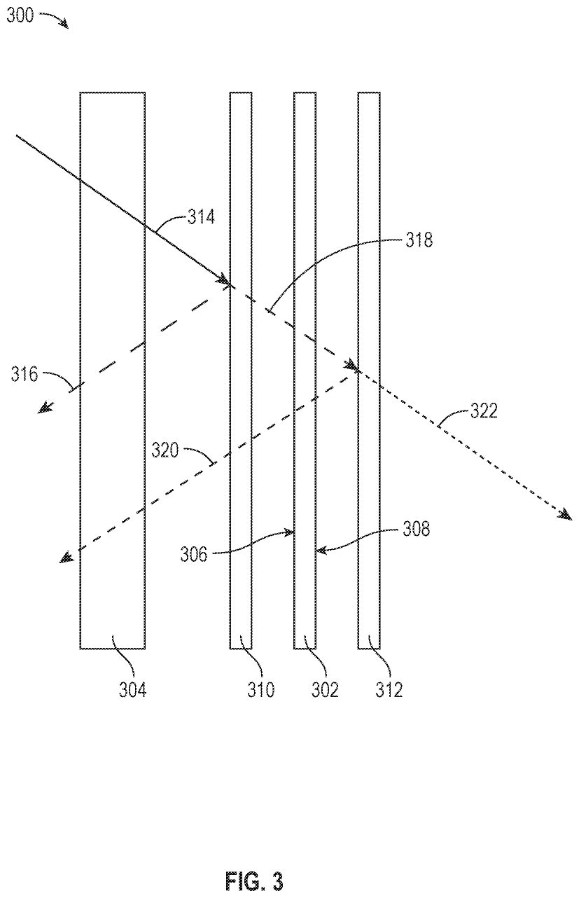

As disclosed herein with respect to at least FIG. 3, strips 106 may include a reflective material applied to first surface 108 and/or second surfaces 110. As disclosed herein, the reflective material may be transparent, semitransparent, and/or opaque to visible light. The reflective material may be transparent, semitransparent, and/or opaque to UV light. The reflective material may be transparent, semitransparent, and/or opaque to IR light. In addition, base material 104 that makes up strips 106 may be semitransparent to visible light, IR light, and/or UV light.

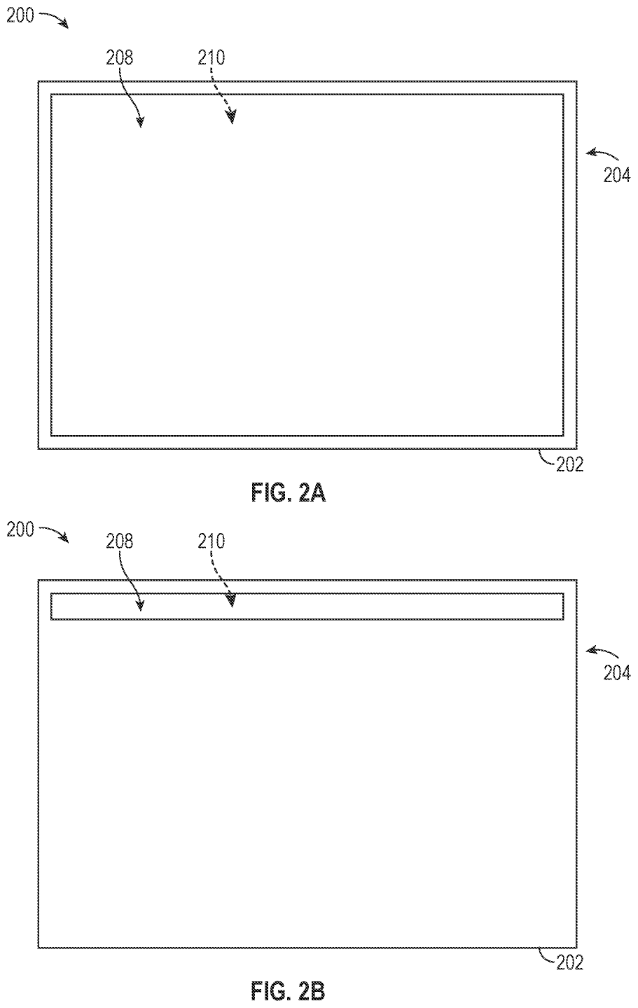

FIGS. 2A and 2B show a window covering system 200 in first and second states in accordance with at least one example of this disclosure.

Window covering system 200 may be suspended proximate a window 202. Window covering system 200 may include a base material 204 that is continuous. An example of base material 204 being continuous may include window blinds that extend from a top of a window as shown in FIG. 2A and roll up on a tube as shown in FIG. 2B.

As shown in FIG. 2A, base material 104 may be in a first state or position where base material covers window 202, When a user wishes to allow light into a room or look outside, the user may cause base material to be rolled up to a second state or position as shown in FIG. 2B. When in the first state, a first surface 208 may face a light source, such as the sun. When in the first state, a second surface 210, which are opposite first surface 208, may face away from the light source. The operation of rollup type window blinds to change from the first state to the second state is known in the art for window blind systems.

As disclosed herein with respect to at least FIG. 3, base material 204 may include a reflective material applied to first surface 208 and/or second surfaces 210. As disclosed herein, the reflective material may be transparent, semitransparent, and/or opaque to visible light. The reflective material may be transparent, semitransparent, and/or opaque to UV light. The reflective material may be transparent, semitransparent, and/or opaque to IR light. In addition, base material 204 may be semitransparent to visible light, IR light, and/or UV light.

FIG. 3 shows a schematic of a window covering system 300 in accordance with at least one example of this disclosure. Window covering system 300 may include a base material 302, such as base materials 104 and/or 204, that may be suspended proximate a window 304, such as windows 102 and/or 202. Base material 302 may have a first side 306 and a second side 308. A first reflective material 310 may be attached to first side 306 and a second reflective material 312 may be attached to second side 308.

First reflective material 310 and/or second reflective material 312 may be films that reflect various spectrums of light. For example, first reflective material 310 and/or second reflective material 312 may be transparent, semitransparent, and/or opaque to visible light. First reflective material 310 and/or second reflective material 312 may be transparent, semitransparent, and/or opaque to UV light. First reflective material 310 and/or second reflective material 312 may be transparent, semitransparent, and/or opaque to IR light. In addition, base material 302 may be semitransparent to visible light, IR light, and/or light. As an example base material 302 may be a continuous fabric, a continuous polymer sheet, polymer strips, fabric strips, or any combination thereof. First reflective material 310 and/or second reflective material 312 may be an aluminum material, such as a sheet and/or strips of aluminum.

As shown in FIG. 3, incident light 314 may be emitted from a light source, such as the sun, and may pass through window 304. Upon striking first reflective material 310, a first portion of incident light 314, such as UV or IR light, may be reflected back through window 302 as indicated by arrow 316. The portion of incident light 314 that passes through first reflective material 310 may pass through base material 302 as indicated by reference numeral 318. Upon striking second reflective material 312, a second portion of incident light 314, such as IR or UV light, may be reflected back through base material 302, first reflective material 310, and window 304 as indicated by arrow 320. A third portion of incident light 314 may pass through second reflective material 312 as indicated by arrow 322.

As disclosed herein, depending on the reflectivity and transmissivity of first reflective material 310, base material 304, and second reflective material 312, all of incident light may be reflected back through window 304. For example, first reflective material 310, window 302, and second reflective material 312 may be configured so that first reflective material 310 reflects UV light, base material 304 may reflect visible light, and second reflective material 312 may reflect IR light. Still consistent with examples disclosed herein, first reflective material 310 may reflect UV, IR, and visible light and second reflective material 312 may be omitted. Still consistent with embodiments herein, first reflective material 310 may reflect IR and visible light and second reflective material 312 may be omitted. Still consistent with embodiments disclosed herein, first reflective material 310 may reflect IR light and visible light. Other combinations of reflected and transmitted light are possible and contemplated by the examples disclosed herein.

### Additional Notes

The following, non-limiting examples, detail certain aspects of the present subject matter to solve the challenges and provide the benefits discussed herein, among others.

Example 1 is a window covering system comprising: a base material that is flexible and at least semitransparent to light within a visible spectrum, the base material comprising: a first side that faces a light source when in a first state, and a second side opposite the first side and that faces away from the light source when in the first state; and a reflective material that is: flexible, and opaque to light in at least one of an ultraviolent spectrum and an infrared spectrum.

In Example 2, the subject matter of Example 1 optionally includes wherein the base material and the reflective material each is a continuous material.

In Example 3, the subject matter of any one or more of Examples 1-2 optionally include wherein the base material and the reflective material each comprises a plurality of strips arranged in a vertical direction.

In Example 4, the subject matter of Example 3 optionally includes wherein each of the plurality of strips is rotatable about a respective axis from the first state to a second state, the second state being the first side facing at least partially away from the light source.

In Example 5, the subject matter of any one or more of Examples 1-4 optionally include wherein the base material and the reflective material each comprises a plurality of strips arranged in the horizontal direction.

In Example 6, the subject matter of Example 5 optionally includes wherein each of the plurality of strips is rotatable about a respective axis from the first state to a second state, the second state being the first side facing at least partially away from the light source.

In Example 7, the subject matter of any one or more of Examples 1-6 optionally include wherein the reflective material is an aluminum material.

In Example 8, the subject matter of any one or more of Examples 1-7 optionally include wherein the reflective material is opaque to light in the visible spectrum.

In Example 9, the subject matter of any one or more of Examples 1-8 optionally include wherein the reflective material is semitransparent to light in the visible spectrum.

In Example 10, the subject matter of any one or more of Examples 1-9 optionally include wherein the reflective material is transparent to light in the visible spectrum.

Example 11 is a window covering system comprising: a window blind; and a first reflective material applied to a first side of the window blind that is: flexible, and opaque to light in at least one of an ultraviolent spectrum and an infrared spectrum.

In Example 12, the subject matter of Example 11 optionally includes wherein the first reflective material is an aluminum material.

In Example 13, the subject matter of any one or more of Examples 11-12 optionally include wherein the first reflective material is opaque to light in the visible spectrum.

In Example 14, the subject matter of any one or more of Examples 1-13 optionally include wherein the first reflective material is semitransparent to light in the visible spectrum.

In Example 15, the subject matter of any one or more of Examples 1-14 optionally include wherein the first reflective material is transparent to light in the visible spectrum.

In Example 16, the subject matter of any one or more of Examples 11-15 optionally include a second reflective material applied to a second side of the window blind, the second reflective material being flexible and opaque to light in at least one of the ultraviolent spectrum and the infrared spectrum.

In Example 17, the subject matter of any one or more of Examples 11-16 optionally include wherein the second reflective material is an aluminum material.

In Example 18, the subject matter of Example 17 optionally includes wherein the second reflective material is opaque to light in the visible spectrum.

In Example 19, the subject matter of any one or more of Examples 17-18 optionally include wherein the second reflective material is semitransparent to light in the visible spectrum.

In Example 20, the subject matter of any one or more of Examples 17-19 optionally include wherein the second reflective material is transparent to light in the visible spectrum.

In Example 21, the apparatuses or method of any one or any combination of Examples 1-20 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first.” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 CFR, § 0.72(b), to allow the reader to quickly ascertain the nature of the technical disclosure, it is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A window covering system comprising:
a base material that is flexible and at least semitransparent to light within a visible spectrum, the base material comprising:
a first side that faces a light source when in a first state, and
a second side opposite the first side and that faces away from the light source when in the first state; and
a reflective material that is:
flexible, and
opaque to light in at least one of an ultraviolent spectrum and an infrared spectrum.

2. The window covering system of claim 1, wherein the base material and the reflective material each is a continuous material.

3. The window covering system of claim 1, wherein the base material and the reflective material each comprises a plurality of strips arranged in a vertical direction.

4. The window covering system of claim 3, wherein each of the plurality of strips is rotatable about a respective axis from the first state to a second state, the second state being the first side facing at least partially away from the light source.

5. The window covering system of claim 1, wherein the base material and the reflective material each comprises a plurality of strips arranged in the horizontal direction.

6. The window covering system of claim 5, wherein each of the plurality of strips is rotatable about a respective axis from the first state to a second state, the second state being the first side facing at least partially away from the light source.

7. The window covering system of claim 1, wherein the reflective material is an aluminum material.

8. The window covering system claim 1, wherein the reflective material is opaque to light in the visible spectrum.

9. The window covering system of claim 1, wherein the reflective material is semitransparent to light in the visible spectrum.

10. The window covering system of claim 1, wherein the reflective material is transparent to light in the visible spectrum.

11. A window covering system comprising:
a window blind; and
a first reflective material applied to a first side of the window blind that is:
flexible, and
opaque to light in at least one of an ultraviolent spectrum and an infrared spectrum.

12. The window covering system of claim 11, wherein the first reflective material is an aluminum material.

13. The window covering system of claim 11, wherein the first reflective material is opaque to light in the visible spectrum.

14. The window covering system of claim 1, wherein the first reflective material is semitransparent to light in the visible spectrum.

15. The window covering system of claim 1, wherein the first reflective material is transparent to light in the visible spectrum.

16. The window covering system of claim 11, further comprising a second reflective material applied to a second side of the window blind, the second reflective material being flexible and opaque to light in at least one of the ultraviolent spectrum and the infrared spectrum.

17. The window covering system of claim 11, wherein the second reflective material is an aluminum material.

18. The window covering system of claim 17, wherein the second reflective material is opaque to light in the visible spectrum.

19. The window covering system of claim 17, wherein the second reflective material is semitransparent to light in the visible spectrum.

20. The window covering system of claim 17, wherein the second reflective material is transparent to light in the visible spectrum.
